(19) United States
(12) Patent Application Publication
(10) Pub. No.: US 2017/0337779 A1
(43) Pub. Date: Nov. 23, 2017

(54) CARD GAME DEVICE, CONTROL METHOD FOR CARD GAME, AND PROGRAM

(71) Applicant: SEGA SAMMY CREATION INC., Tokyo (JP)

(72) Inventors: Yuichi Takasaki, Tokyo (JP); Masato Ito, Tokyo (JP); Takayuki Suzuki, Tokyo (JP)

(21) Appl. No.: 15/534,255

(22) PCT Filed: Dec. 9, 2014
(86) PCT No.: PCT/JP2014/082580

§ 371 Date: Jun. 8, 2017

(51) Int. Cl. G07F 17/32

(52) U.S. Cl. CPC G07F 17/3288; G07F 17/3293; G07F 17/3216; G07F 17/3234; G07F 17/3258

(57) ABSTRACT

To provide a technique related to a card game capable of providing a unique game full of originality different from existing games. A bet area comprises a main bet area Am and a side bet area As. The main bet area Am is the same as a bet area adopted in existing Baccarat. On the other hand, the side bet area As is a unique bet area adopted in new Baccarat and is configured by a new player area As1 for betting that a player wins and a new banker area As2 for betting that a banker wins.

### CROSS-REFERENCE TO RELATED APPLICATIONS

This application is the U.S. national phase of the International Patent Application No. PCT/JP2014/082580 filed Dec. 9, 2014, the entire content of which is incorporated herein by reference.

### TECHNICAL FIELD

The present disclosure relates to a card game device, a control method for a card game, and a program.

### BACKGROUND

Baccarat, which is one of representative card games, is a game in which users predict and bet on win or loss of a card game played by a banker (playing a role of a bookmaker) and a player (playing a role of a customer). The users simply predict win or loss of the card game. Baccarat is popular in casinos in places in the world because of easiness and the like of the game. A dealer deals out two or three cards to each of the banker and the player according to certain rules. The banker or the player having a total number of the dealt-out cards closer to “9” wins the game. The users predict whether the banker wins (BANKER), the player wins (Player), the game ends in a tie (TIE), or the like and bet in a predetermined bet area on the basis of prediction results (see, for example, areas a1 to a5 shown in FIG. 14). The users can optionally designate bet amounts. When the predictions of the users come true, the users obtain dividends corresponding to the bet amounts (see, for example, Japanese Patent Laid-Open No. 11-267264).

### SUMMARY

As explained above, because of the simplicity of the game, one attraction of Baccarat is that even a beginner of card games can readily enjoy the game. On the other hand, there is a problem in that, since game rules are uniform, an operator that provides Baccarat to users cannot add uniqueness to the game to show originality.

The present disclosure has been devised in view of the circumstances explained above and an object of the present disclosure is to provide a technique related to a card game capable of providing a unique game full of originality different from existing games.

In order to solve the problem, a card game device according to an embodiment of the present disclosure is a card game device that controls progress of a game played between a player and a banker, the card game device comprising: an input unit that receives bet operation on the player by a user or bet operation on the banker by the user; a collecting unit that collects a total amount of bet amounts corresponding to the bet operation on the player or the bet operation on the banker when the game ends in a tie; a memory that stores dividend information that specifies a dividend at a time when the player wins and a dividend at a time when the banker wins; and a dividend determining unit that determines a dividend amount given to the user on the basis of a win or loss result of the game, a bet situation corresponding to the bet operation on the player or the bet operation on the banker by the user, and the dividend information when the player or the banker wins and win or loss of the game is decided.

In the configuration, it is preferable that the card game device further comprises: a jackpot drawing unit that performs a drawing of a jackpot when the bet by the user comes true; and an additional-dividend determining unit that determines, when the user wins the jackpot, using dividend information of a progressive dividend corresponding to the jackpot, an additional dividend amount given to the user.

Further, in the configuration, a plurality of ranks with different dividends may be present in the jackpot, and the card game device may further include a jackpot control unit that controls, according to the bet situation by the user, winning probabilities of the jackpot corresponding to the ranks.

Another card game device according to an embodiment of the present disclosure is a card game device that controls progress of a game played between a player and a banker, the card game device executing a first game for enabling only a bet on the player or a bet on the banker and a second game for enabling the bet on the player, the bet on the banker, or a bet on a tie, the card game device comprising: an input unit that receives input operation of the games by a user; a memory that stores dividend information that specifies dividends related to the games; a collecting unit that collects a total amount of bet amounts corresponding to bet operation on the player by the user or bet operation on the banker by the user in the second game when the second game ends in a tie; and a dividend determining unit that determines, on the basis of win or loss results in the games, dividend information corresponding to the games, and a bet situation corresponding to the bet operation in the games by the user, a dividend amount given to the user.

In the configuration, it is preferable that a dividend at a time when the player wins, a dividend at a time when the banker wins, and a dividend at a time when the first game ends in a tie are specified in the dividend information related to the first game, and a dividend at a time when the player wins and a dividend at a time when the banker wins are specified in the dividend information related to the second game.

In the configuration, it is preferable that the dividend at the time when the player wins and the dividend at the time when the banker wins in the second game are respectively set higher than the dividend at the time when the player wins and the dividend at the time when the banker wins in the first game.

According to the present disclosure, it is possible to provide a unique game full of originality different from existing games.

### BRIEF DESCRIPTION OF THE DRAWINGS

FIG. 1 is a schematic configuration diagram of a card game device in an embodiment of the present disclosure;

FIG. 2 is a diagram showing an overview of a card game;

FIG. 3 is diagram showing a display example of a display device;

FIG. 4 is a system block diagram of a server computer;

FIG. 5 is an exterior view of a station device;

FIG. 6 is a system block diagram of the station device

FIG. 7 is a diagram illustrating stored contents of a ROM;

FIG. 8 is a diagram illustrating stored contents of a RAM;

FIG. 9 is a diagram showing a display example of the display device;

FIG. 10 is a flowchart showing bet control processing;

FIG. 11 is a flowchart showing jackpot control processing;

FIG. 12 is a flowchart showing processing executed by a master device;

FIG. 13 is a flowchart showing processing executed by the station device; and

FIG. 14 is a conceptual diagram for explaining game content of existing Baccarat.

### DETAILED DESCRIPTION

An embodiment of the present disclosure is explained in detail below. Note that the embodiment explained below is an illustration for explaining the present disclosure and is not meant to limit the present disclosure to only the embodiment. Various modifications of the present disclosure are possible as long as the modifications do not deviate from the gist of the present disclosure. Further, those skilled in the art can adopt an embodiment in which elements explained below are replaced with equivalent elements. Such an embodiment is also included in the scope of the present disclosure. Furthermore, positional relations such as up and down and left and right shown according to necessity are based on illustrated display unless specifically noted otherwise. Furthermore, various dimension ratios in the drawings are not limited to the illustrated ratios.
A. Embodiment
A-1. Card Game Device.

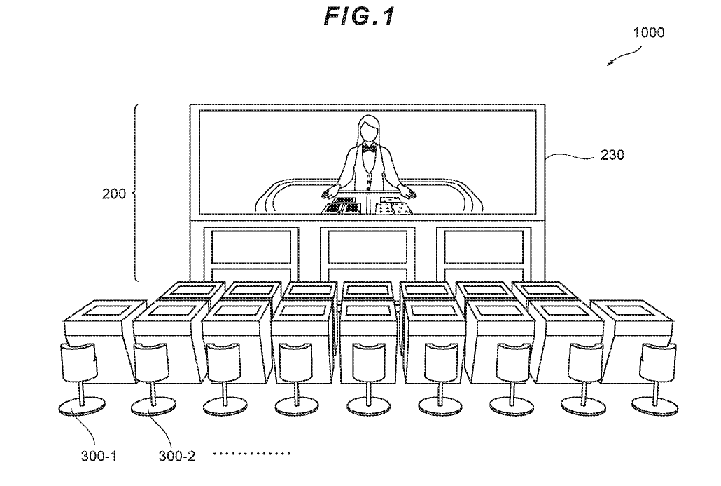

FIG. 1 is a schematic configuration diagram showing a preferred embodiment of a card game device according to the present disclosure.

A card game device (a game device) 1000 comprises a master device 200 that controls a card game advanced on a certain table and a plurality of station devices 300-N (N≧2) for users to perform bet operation in the advanced card game. In this embodiment, “Baccarat” is assumed as the card game. Note that, as explained above, Baccarat is a game in which users predict and bet on win or loss of the card game played by a banker (playing a role of a bookmaker) and a player (playing a role of a customer) and, when the predictions of the users come true, the users obtain dividends corresponding to bet amounts or the like of the user. When it is unnecessary to distinguish the station devices 300-N in particular, the station devices 300-N are simply referred to as station devices 300.

The master device 200 and the station devices 300 are connected to each other by wire and/or radio via a LAN (Local Area Network), a WAN (Wide Area Network), or a communication network such as the Internet. Users participating in the game take seats in unoccupied station devices 300. The users predict win or loss of the advanced card game and bet chips corresponding to bet amounts according to the predictions.

As one of characteristics of this embodiment, not only Baccarat conforming to existing rules can be carried out but also Baccarat conforming to unique rules full of originality can be carried out. For convenience, in the following explanation, the Baccarat conforming to the existing rules is referred to as “existing Baccarat” and new Baccarat adopted in the present disclosure is referred to as “new Baccarat”. Note that, in the following explanation, it is assumed that both of the existing Baccarat and the new Baccarat can be played using one card game advanced on a certain table. However, only the new Baccarat can be played. In the following explanation, for convenience, bet operation in the existing Baccarat is referred to as “main bet” and bet operation in the new Baccarat is referred to as “side bet”.

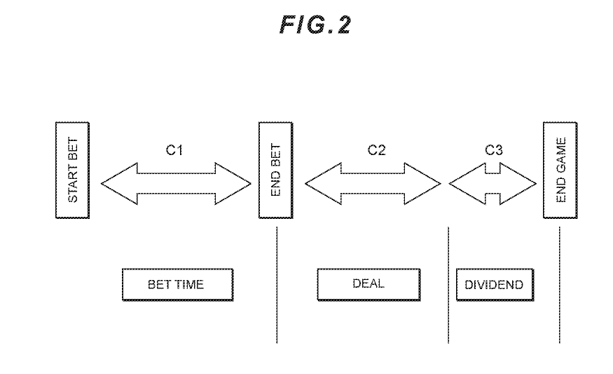

FIG. 2 is a conceptual diagram showing an overview of a game that makes use of the existing Baccarat and the new Baccarat.

First, the user performs the main bet (a bet on the “existing Baccarat”) or the side bet (a bet on the “new Baccarat”) or the main bet and the side bet in a period from a bet start to a bet end (see C1 shown in FIG. 2). As explained in detail below, the user can perform the main bet and the side bet according to predetermined touch panel operation or the like. When the bet period ends, cards are dealt out to a player (PLAYER) and a banker (BANKER) (so-called “deal”) and the game progresses (C2 shown in FIG. 2). When win or loss of the card game is decided, a dividend of the main bet and a dividend of the side bet (in some case, a progressive dividend (explained below)) are determined, payout is performed, and the game ends (see C3 shown in FIG. 2).

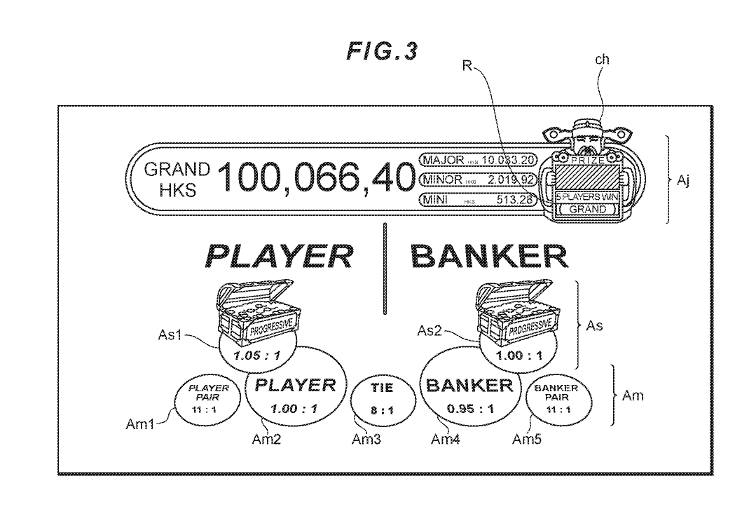

A difference between the main bet and the side bet is explained in detail with reference to FIG. 3. FIG. 3 is a diagram illustrating a bet area where the main bet and the side bet according to this embodiment are performed. The bet area comprises a main bet area Am and a side bet area As. The main bet area Am is the same as a bet area adopted in the existing Baccarat and is configured by a player pair area Am1, a player area Am2, a tie area Am3, a banker area Am4, and a banker pair area Am5. The player pair area Am1 is an area for betting that first two cards of the player have the same number. The player area Am2 is an area for betting that the player wins. The tie area Am3 is an area for betting that the player and the banker end in a tie. The banker area Am4 is an area for betting that the player wins. The banker pair area Am5 is an area for betting that first two cards of the player have the same number.

On the other hand, the side bet area As is a unique bet area adopted in the new Baccarat and is configured by a new player area As1 for betting that the player wins and a new banker area As2 for betting that the banker wins. In this way, the side bet in this embodiment is different from the main bet in that it is possible to only bet which of the player and the banker “wins”, that is, the player wins or the banker wins. Concerning dividends, as it is evident from table display (see FIG. 3), a dividend rate is set higher in the side bet than the main bet. Specifically, a dividend rate in the case of a bet on the player side in the main bet is “2” and a dividend rate in the case of a bet on the banker side in the main bet is “1.95”. On the other hand, a dividend rate in the case of a bet on the player side in the side bet is “2.05” and a dividend rate in the case of a bet on the banker side in the side bet is “2”.

Further, when the user operates a touch panel 352 to thereby perform a bet on “player” (the new player area As1) or “banker” (the new banker area As2) of the side bet area As, the user is capable of receiving progressive dividends of ranks displayed in a jackpot area Aj. In the jackpot area Aj, four ranks of “GRAND”, “MAJOR”, “MINOR”, and “MINI” are displayed in a descending order of dividends. The rank of the jackpot is determined by the master device 200 (details are explained below). A drawing result is displayed on a jackpot reel R held by a character ch displayed in the jackpot area Aj. That is, when a bet end time comes, rotation of the reel held by the character ch stops. A rank of a jackpot determined by the station device 300 is displayed on the reel (see FIG. 3). A device configuration and the like for realizing such a card game are explained below.
A-2. Master Device

The master device 200 shown in FIG. 1 comprises a server computer that centrally controls the progress of the card game and a main monitor 230 provided in the center of the master device 200. For example, as shown in FIG. 1, the card game or the like currently in progress is displayed on the main monitor 230. However, it is possible to set and change as appropriate according to design and the like of the master device 200 what kinds of information is displayed on the main monitor 230 in what kind of form (e.g., a gazing point is switched at every predetermined time).
A-3. Sever Computer

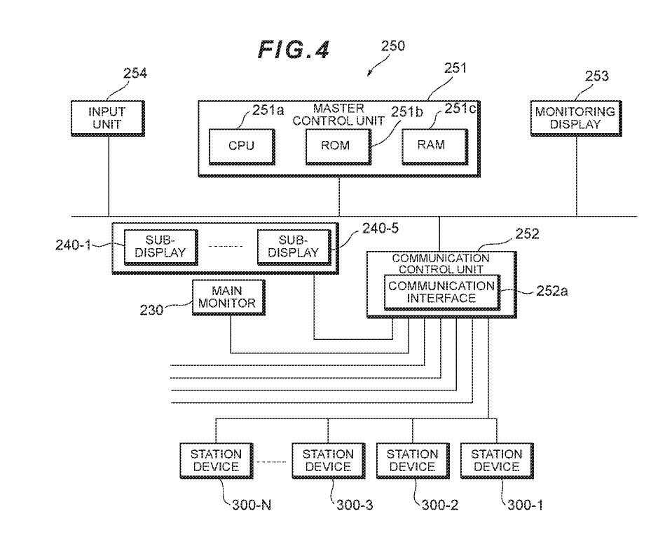

FIG. 4 is system block diagram of a server computer 250 provided in the master device 200. The server computer 250 comprises a master control unit 251, a communication control unit 252, a monitoring display 253, and an input unit 254.

On the monitoring display 253 of the server computer 250, besides a menu screen and the like, a maintenance screen for a person having a specific authority concerning the card game (e.g., an operator of the card game; hereinafter referred to as “operator or the like” as appropriate) to perform maintenance work is displayed. The operator or the like is capable of performing various kinds of maintenance work such as setting and adjustment of display luminance and sound volume of the main monitor 230 and a sub-display 240 by operating a keyboard, a mouse, and the like provided in the input unit 254.

The master control unit 251 assumes a function of centrally controlling the master device 200 and comprises a CPU 251a, a ROM 251b, and a RAM 251c. The CPU 251a is connected to a timer (not shown in the figure) or the like via a bus. The master control unit 251 performs exchange of data between the master control unit 251 and the station devices 300 via a communication interface 252a.

Explaining in detail, the CPU 251a performs various kinds of processing on the basis of signals supplied from the station devices 300 and data and programs stored in the ROM 251b and the RAM 251c and transmits various commands to the station devices 300 according to results of the various kinds of processing. Further, in order to initiatively controlling the station devices 300 to advance a game, the CPU 251a transmits a signal for synchronizing timing (a synchronization signal) to the station devices 300. The station devices 300 control, on the basis of the synchronization signal received from the master device 200, the progress of a plurality of card games simultaneously advanced. Consequently, it is possible to simultaneously advance the plurality of card games in a synchronized state between the master device 200 and the station devices 300.

The station devices 300 determines on the basis of win or fail results of the plurality of card games simultaneously advanced and bet information input by the player whether prediction of the user comes true. The station devices 300 performs, for example, calculation of a credit number (i.e., a dividend) that should be paid out to the user according to a determination result.

The ROM 251b stores a program for realizing a basic function of the master device 200, a dividend rate table for determining a dividend rate, a program for initiatively controlling the station devices 300, and the like. In the dividend rate table, not only a dividend of the main bet (i.e., a dividend related to win or fail of the card game adopted in the existing Baccarat) but also a dividend of the side bet (i.e., a dividend related to win or fail of the card game adopted in the new Baccarat) is registered. In the ROM 251b, for example, an algorithm for determining dividends (i.e., progressive dividends) of ranks of a jackpot through a drawing is also stored.

Further, in the ROM 251b, actually filmed moving image data of a dealer, 3DCG data for a background for creating a background video comprising a table, 3DCG data for a card for creating a card video, a display algorithm for displaying a combined video on the main monitor 230 on the basis of these data, and the like are stored. The actually filmed moving image data of the dealer is, for example, moving image data obtained by actually photographing a model dealer on a green back. The 3DCG data for the background and the 3DCG data for the card are data for creating the background comprising the table and the card as 3D models using three-dimensional computer graphics. The CPU 251a is capable of displaying a game moving image full of realistic sensations on the main monitor 230 by combining these data (chroma key combination, etc.) according to the display algorithm.

Note that, in this embodiment, the ROM 251b exclusive for readout is assumed. However, instead of the ROM 251b, a rewritable EEPROM 251b may be used. When the EEPROM 251b is used, the operator or the like is capable of rewriting, at appropriate timing, various programs, data, and the like stored in the EEPROM 251b.

On the other hand, the RAM 251c stores bet information transmitted from the station devices 300 on a real-time basis, progress information representing progress situations (e.g., situations of cards dealt out to the player and the banker) of a plurality of card games simultaneously advanced, various data transferred from the ROM 251b, a result of processing executed by the CPU 251a, and the like.
A-4. Station Device

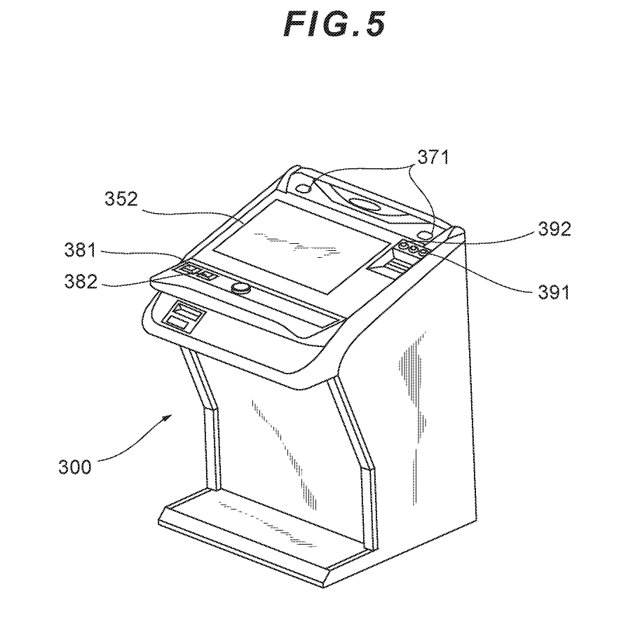

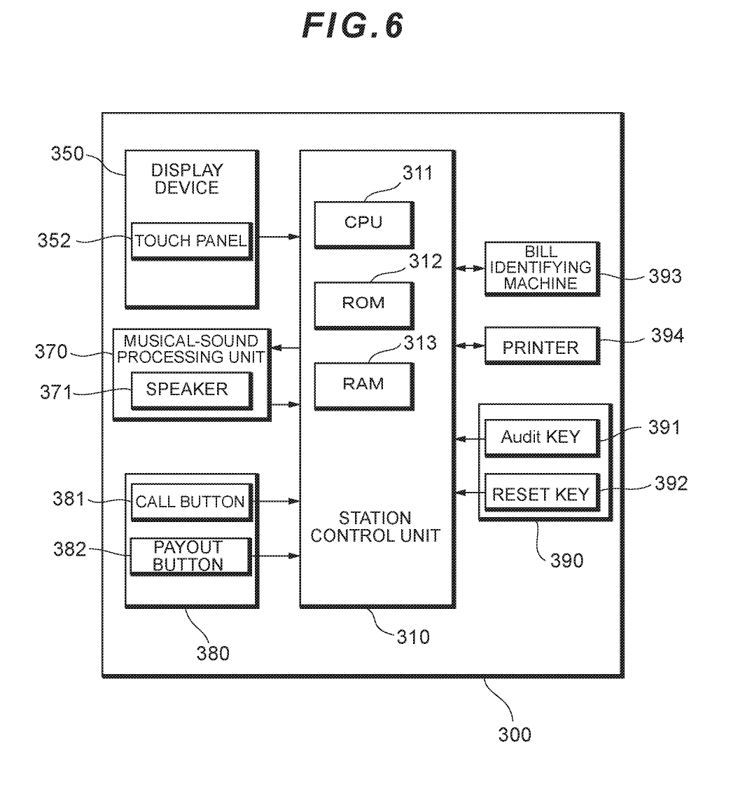

FIG. 5 is an exterior perspective view of the station device 300. FIG. 6 is a system block diagram of the station device 300. Note that, in FIG. 5 and FIG. 6, corresponding portions are denoted by the same reference numerals and signs. Explanation is omitted concerning redundant portions.

A station control unit 310 comprises a CPU 311, a ROM 312, and a RAM 313. The CPU 311 centrally controls the units of the station device 300 by using various control programs and control data stored in the ROM 312 and the RAM 313. In the ROM 312 and the RAM 313, an algorithm necessary for calculation of dividends, a table for displaying the dividends, and the like in the station devices 300 are stored.

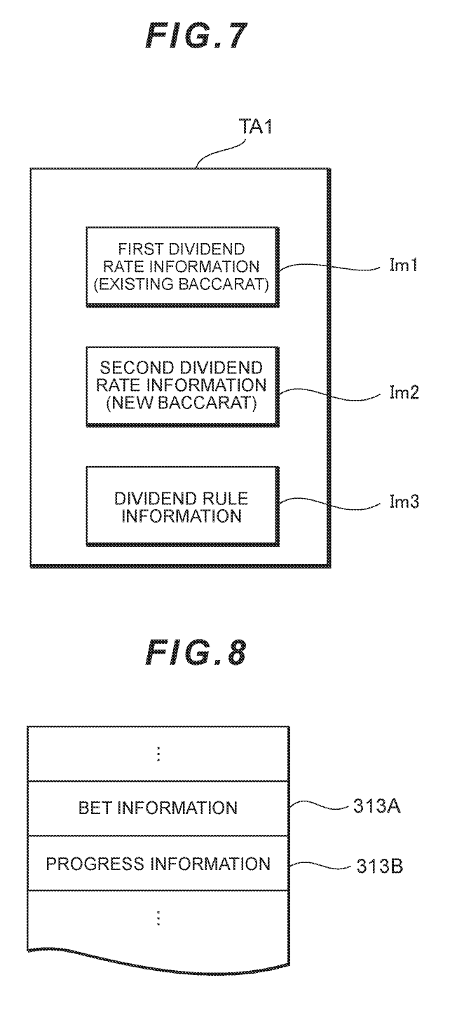

FIG. 7 is a diagram illustrating a dividend rate table TA1 stored in the ROM (a memory) 312. As shown in FIG. 7, in the dividend rate table TA1, first dividend rate information Im1 indicating a dividend of the main bet, that is, the existing Baccarat (a second game), second dividend rate information Im2 indicating a dividend of the side bet, that is, the new Baccarat (a first game), and dividend rule information Im3 are stored. Note that, the dividends (i.e., the progressive dividends) of the ranks of the jackpot are determined by the master device 200 as explained above and notified to the station devices 300.

Explaining in detail, as the first dividend rate information Im1 concerning the existing Baccarat, besides “PLAYER” (a dividend rate: 2) for betting on the player side, “BANKER” (a dividend rate: 1.95) for betting on the banker side, and “TIE” (a dividend rate: 9) for betting on a tie, there are “PLAYER PAIR” (a dividend rate: 12) for betting that first two cards of the player have the same number and “BANKER PAIR” (a dividend rate: 12) for betting that first two cards of the banker have the same number.

On the other hand, as the second dividend information Im2 concerning the new Baccarat, two kinds of the player side and the banker side are present. A dividend rate in the case of a bet on the player side (“PLAYER”) is 2.05. On the other hand, a dividend rate in the case of a bet on the banker side (“BANKER”) is 2. As explained above, the dividend rate is set higher in the case of the bet on the player or the banker in the side bet than in the case of the bet on the player or the banker in the main bet because rules and the like of payback in the case of a tie are different. That is, in the existing Baccarat, in a state in which the user bets on the player or the banker, when the game ends in a tie, a betted amount (a bet amount) is returned as it is, that is, an original amount is returned. On the other hand, in the new Baccarat, in a state in which the user bets on the player or the banker, when the game ends in a tie, the bet amount is collected by the station device 300 (i.e., the operator side) as a fund of the jackpot without being paid back at all. Such dividend rules are registered in the dividend rate table TA1 as the dividend rule information Im3.

Further, in the ROMs 312 of the station devices 300, as in the master device 200, actually filmed moving image data of the dealer, 3DCG data for a background for creating a background video comprising the table, 3DCG data for a card for creating a card video, a display algorithm for displaying a combined video on the main monitor 230 on the basis of these data, and the like are stored. As in the master device 200, the CPUs 311 are capable of displaying a game moving image full of realistic sensations on the display devices 350 by combining these data (chroma key combination, etc.) according to the display algorithm.

Note that, in this embodiment, the ROM 312 exclusive for readout is assumed. However, instead of the ROM 312, a rewritable EEPROM 312 may be used. By using the EEPROM, the operator or the like is capable of rewriting, at appropriate timing, registered contents (i.e., dividend rates and dividend rules) of the dividend rate table TA1 stored in the EEPROM using the station devices 300. For example, when a dividend rate rewriting command is input to the station devices 300 by the operator or the like, the CPU 311 performs, according to the rewriting command, rewriting of the dividend rate table TA1 stored in the EEPROM.

On the other hand, in the RAM 313, as shown in FIG. 8, a first storage area 313A in which bet information representing a bet situation of the user is stored, a second storage area 313B in which progress information representing a progress situation (e.g., a situation of cards dealt out to the player and the banker) of the card game is stored, and the like are provided. Note that, in the following explanation, unless specifically noted otherwise, the “bet information” refers to information concerning bet operation performed by the user using the station device 300 such as a bet situation of the main bet and a bet situation of the side bet (both comprising a bet target and the number of bets) by the user.

Referring back to FIG. 6, the display device 350 displays various screens such as a main screen under the control by the station control unit 310.

The touch panel 352 is provided on the front surface of the display device 350. The touch panel 352 is used to perform various kinds of operation (a bet of chips, etc.) related to the card game.

A musical-sound processing unit 370 reads out musical sound data or the like stored in various memories and storage media and reproduces the musical sound data or the like to thereby generate effective sound, music, and the like in performing various kinds of performance. The generated musical sound such as the effective sound is output to the outside via a speaker 371.

An operation button group 380 comprises a call button 381 for calling a store clerk when a deficiency or the like occurs and a payout button 382 for requesting dispensing of a ticket corresponding to credit. The user is capable of operating all of these operation buttons.

A setting key group 390 comprises an Audit key 391 for operating the station device 300 on trial and a reset key 392 operated by the store clerk to dispense a ticket or the like. The operator or the like of the card game is capable of setting and operating these keys.

A bill identifying machine 393 is a device that identifies, for example, when the user participates in the card game, a type, an amount, and the like of bills (e.g., bills in Japanese yen or bills in Hong Kong dollar) input via a cash input port. A printer 394 is a device for printing a ticket dispensed after a game ends or the like.
A-5. Explanation of Basic Operation

In a period when the card game is started and bet operation is possible, the users predict win or loss of the card game in a selected table. Specifically, the users predict whether the banker wins (BANKER), the player wins (PLAYER), or the game ends in a tie (TIE) and operates the touch panel 352 to thereby bet chips in corresponding parts of the main bet area Am (i.e., the main bet) according to prediction results (see FIG. 3).

Further, the user performs the side bet on the basis of the prediction or the like of the user. In this embodiment, a form in which the side bet is possible irrespective of presence or absence of the main bet (i.e., a form in which the side bet is received even if the main bet is absent) is assumed. However, for example, a form may be adopted in which the side bet is not received unless the main bet is present. As explained above, the side bet is a form in which the user bets on the player or the banker. The user performs a bet on the “player” (the new player area As1) or the “banker” (the new banker area AS2) of the side bet area As according to a prediction result (see FIG. 3).

After the user performs the bet in the “player” or the “banker” of the side bet area As, when the bet period ends, win or loss of the card game is decided and dividends in the main bet and the side bet are determined. When it is found that the prediction of the user comes true and the user wins the side bet, a drawing for determining a rank of the jackpot is performed. The rank of the jackpot is determined by the master device 200. This is notified to the station device 300 corresponding to the rank. The station device 300 controls, on the basis of a drawing result (e.g., “MINI”) of the rank of the jackpot notified from the master device 200, the rotation of the jackpot reel R held by the character ch displayed in the jackpot area Aj and notifies the user of the rank of the jackpot. That is, when the user wins the side bet, the rotation of the reel R held by the character ch is started. Finally, the rank of the jackpot determined by the station device 300 is displayed on the reel (see FIG. 3). Note that, as the rank of the jackpot, four ranks of “GRAND”, “MAJOR”, “MINOR”, and “MINI” are present in order from the rank with the highest dividend. Besides, “-” (blank) meaning “miss” is also present. However, when the drawing of the rank of the jackpot is performed without providing the “-” (blank), control may be performed such that the user always wins the jackpot of any one of the ranks. In this case, the drawing of the rank of the jackpot is not performed (i.e., even if the user wins the side bet, the rotation of the reel held by the character ch is not started). Therefore, the user can grasp that the jackpot is not won.

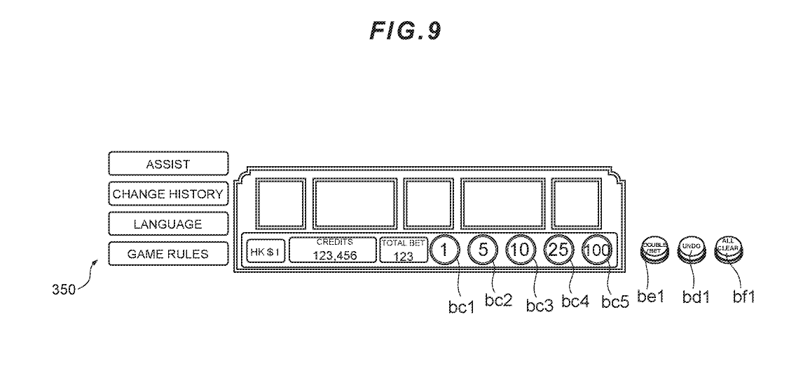

Please take note that, when the station control unit 310 determines the rank of the jackpot, a bet situation (e.g., a bet amount) of the side bet of the user is taken into account. Specifically, as the bet amount of the side bet of the user is higher, an appearance ratio of a high rank of a dividend is higher. Various operation contents and display contents are explained with reference to FIG. 9 and the like.
Basic Bet Operation

The user operates the touch panel 352 with a finger or the like to thereby perform bet operation in a desired area. Specifically, after touching a chip desired to be bet out of chips bc1 to bc5 in credit units of “1”, “5”, “10”, “25”, and “100” displayed on the touch panel 352, the user touches a place where the user desired to perform the bet. For example, when the user predicts that the player side wins, the user touches a bet area (a square) on the player side of the main bet area Am. Then, a predetermined chip (e.g., “100”) designated by the user is bet at an instance of the touch. Note that, by repeating the touch of the bet area, it is possible to increase the number of bets to “100”, “200”, “300”, and the like. The user is capable of easily and quickly betting a large quantity of chips by operating chip switching buttons bc1 to bc5 as appropriate. Such operation is performed in the same manner in the side bet area As.
Specific Bet Function

The user is capable of resetting (cancelling) the immediately preceding operation by touching an undo button bd1 shown in FIG. 9 and the like. Note that, setting may be performed such that all kinds of bet operation performed in the game are cancelled when the undo button bd1 is continuously depressed a predetermined number of times or more. However, a way of the setting can be changed according to, for example, design of the station device 300. By touching a double bet button be1, the user is capable of increasing the number of credits touched immediately before the touch to a double. The double bet button be1 may be enabled, for example, only when the double bet button be1 is operated within a predetermined time from a bet time start. However, a way of setting the double bet button be1 can be changed according to, for example, the design of the station device 300. Furthermore, by touching an all clear button bf1, the user is capable of clearing all kinds of bet operation performed by the user to that point. Note that, as other functions, a history display function for displaying history of the card game (e.g., details (a win or loss pattern, etc.) of a win or loss history and a winning percentage (statistical information, etc.) in several ten games in the past) with the touch panel operation by the user, an assist display function for performing assist display of win determination conditions on the display device 350 (e.g., when a card to be dealt out to the player next is “◯x . . . ”, displaying content indicating that the “player” wins), and the like are mounted. Bet control processing executed by the station control units 310 is explained.
Bet Control Processing

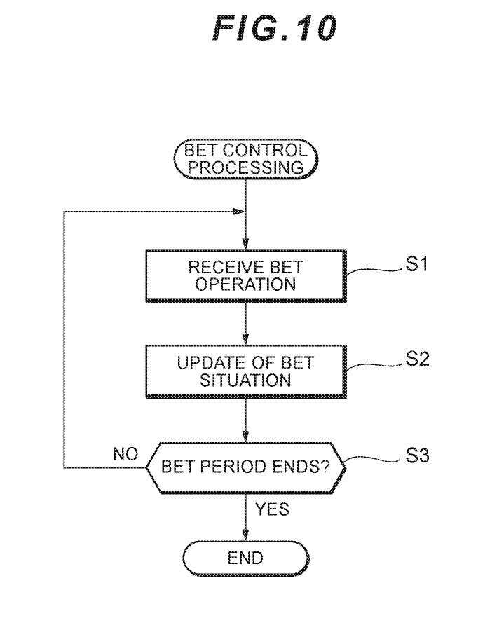

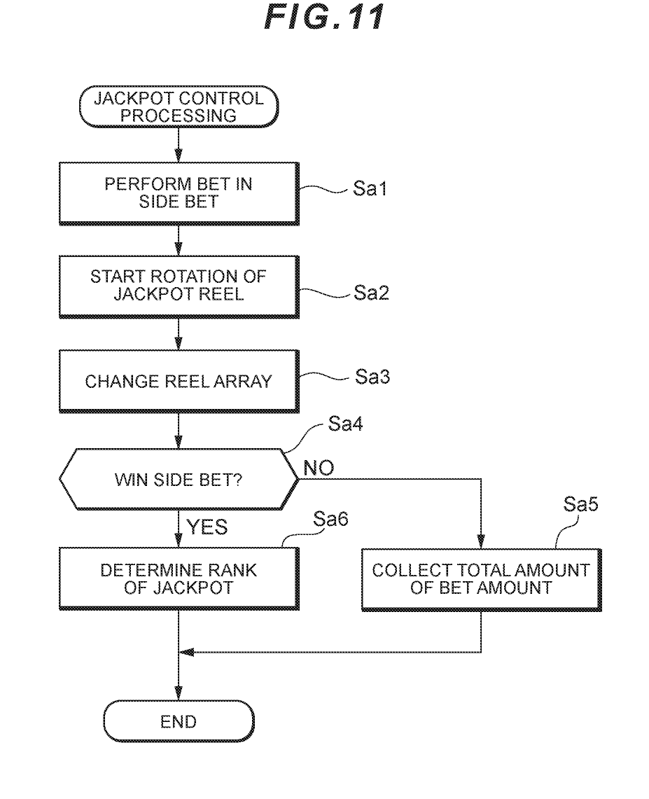

FIG. 10 is a flowchart showing the bet control processing executed by the station control units 310.

The station control unit 310 starts reception of bet operation by the user. The station control unit 310 determines which of the main bet (i.e., the bet operation for the existing Baccarat) and the side bet (i.e., bet operation for the new Baccarat) the bet operation by the user is. When detecting bet operation in the main bet area Am, the station control unit (an input unit) 310 determines that the bet operation is the main bet. On the other hand, when detecting bet operation in the side bet area As, the station control unit (the input unit) 310 determines that the bet operation is the side bet. When grasping content of the bet operation, the station control unit 310 updates a bet situation (step S2). Thereafter, the station control unit 310 determines, referring to a timer or the like, whether the bet period has ended (step S3). When determining that the bet period has not ended (NO in step S3), the station control unit 310 returns to step S1 and repeatedly executes the processing explained above. On the other hand, when determining that the bet period has ended (YES in step S3), the station control unit 310 ends the processing explained above.
Jackpot Control Processing

FIG. 11 is a flowchart showing jackpot control processing intermittently executed in the station control units 310.

When detecting that the side bet is performed on the basis of the bet operation by the user (step Sa1), the station control unit 310 starts rotation of the jackpot reel R (see, for example, FIG. 3) displayed in the jackpot area Aj (step Sa2). The station control unit 310 changes a reel array according to a bet situation of the side bet (step Sa3). The change of the reel array is explained in detail. In the ROM 312 and the RAM 313 of the station control unit (a jackpot control unit) 310, a determination algorithm for determining the ranks (“GRAND”, “MAJOR”, “MINOR”, and “MINI”) or “-” (blank) indicating “miss” of the jackpot according to a bet situation of the side bet is stored. In this embodiment, the ranks of the jackpot are changed according to a total number of credits and the like in the side bet. For example, as the number of credits of the side bet in one game is larger, appearance ratios (winning probabilities) of “GRAND” and “MAJOR” with high dividend rates are set higher and, on the other hand, appearance ratios (winning probabilities) of “MINOR”, “MINI”, and “-” (blank) with low dividend rates are set lower. Conversely, when the number of credits of the side bet in one game is small, the appearance ratios of “GRAND” and “MAJOR” with high dividend rates are set low and, on the other hand, the appearance ratios of “MINOR”, “MINI”, and “-” (blank) with low dividend rates are set high. However, it is possible to appropriately set, according to, for example, design of the determination algorithm, how appearance ratios of the ranks of the jackpot are changed according to, for example, the number of credits of the side bet. Thereafter, when the bet period ends, the station control unit 310 determines on the basis of win or loss information of the card game (hand information of the player and the banker, etc.) notified from the master device 200 whether the user wins the side bet (step Sa4). When determining that the user does not win the side bet (NO in step Sa4), the station control unit 310 collects a total amount of a bet amount (step Sa5). Specifically, it is conceivable that a party (e.g., the banker) different from a party on which the user bets (e.g., the player) wins or the player and the banker end in a tie. In both the cases, a total amount bet by the user is collected by the station control unit (a collecting unit) 310 (step Sa5). Note that a part of the bet amount is used as a fund of the jackpot.

On the other hand, when determining that the user wins the side bet (YES in step Sa4), the station control unit (a jackpot drawing unit) 310 stops the rotation of the jackpot reel R, determines a rank of the jackpot (step Sa6), and thereafter ends the processing. In the jackpot of which rank the user wins is determined by, for example, the station control unit 310 performing a random drawing. However, the array itself of the jackpot reel R is changed according to a bet situation by the user. Therefore, as the number of credits of the side bet is larger, the wining probabilities of “GRAND” and “MAJOR” with high dividend rates are higher.

Thereafter, the station control unit (a dividend determining unit) 310 compares bet information representing a bet situation of the user (bet situations of the main bet and the side bet) and win or loss information representing a win or loss result of the card game to thereby determine a dividend. In this case, when detecting acquisition of the jackpot on the basis of, for example, notification from the master device 200, for example, the station control unit 310 highlights a rank (e.g., “MAJOR”) of the won jackpot to notify the user of the acquisition of the jackpot. Note that, when the jackpot is acquired by any station device 200, showy performance for notifying the acquisition of the jackpot is displayed on the main monitor 230 of the main device 200.

Note that progressive dividends are respectively allocated to the ranks “GRAND”, “MAJOR”, “MINOR”, and “MINI” of the jackpot excluding the “-” (blank). The progressive dividends allocated to the ranks are successively notified to the station devices 300 from the master device 200. The station control units 310 appropriately update, on the basis of the notification from the master device 200, the progressive dividends displayed on the display device 350. In this embodiment, when the acquisition of the jackpot is decided, the station control unit (an additional-dividend determining unit) 310 gives a progressive dividend allocated to a rank (e.g., “GRAND”) of the jackpot at this point in time to the user in addition to a dividend of the side bet (on the player side, “×2.05”).

In this embodiment, by changing the appearance ratios of the ranks of the jackpot according to the bet situation in the side bet in this way, it is possible to improve amusement of the side bet. In the jackpot, the plurality of ranks of “GRAND”, “MAJOR”, “MINOR”, “MINI”, and “-” (blank) are set and the dividends allocated to the respective ranks are different. Therefore, it is possible to further improve amusement of the jackpot as well.

Further, the appearance ratios of the ranks are different for each of the users (i.e., according to situations of the side bet of the users). Therefore, for example, by observing reactions of the users, audiences can enjoy the game together.
B. Explanation of Processing Flowcharts of the Devices
B-1. Master Device 200

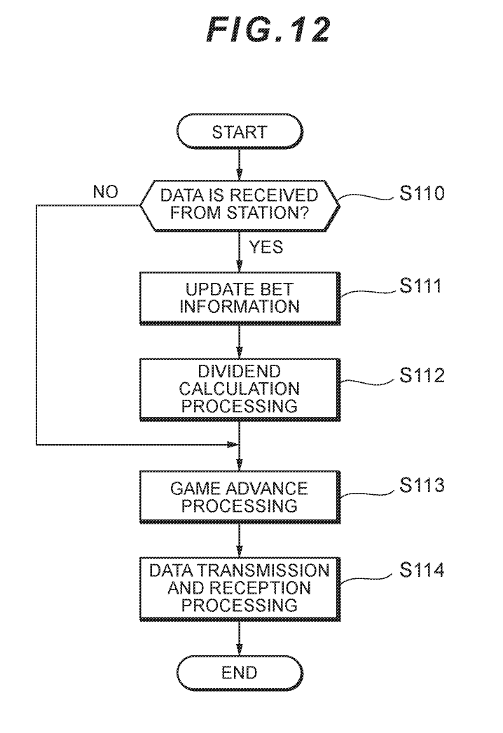

A flowchart for explaining processing executed by the master device 200 is shown in FIG. 12. Maser processing related to the flowchart is repeatedly executed periodically (e.g., at every 1/60 second) at every predetermined update timing. Note that processing contents of steps explained below are illustrations. The order of the steps may be changed, a plurality of steps may be processed as one step, or one step may be separated into a plurality of steps and processed.

First, the master control unit 251 of the master device 200 determines whether data is received from the station devices 300 (step S110). When determining that data is not received (NO in step S110), the master control unit 251 proceeds to step S113 and performs game advance processing. When determining that data is received from the station devices 300 (YES in step S110), the master control unit 251 discriminates a type of the received data. When the received data is data concerning a change of a bet situation in the station device 300, the master control unit 251 updates bet information of the users stored in the RAM 213 (step S111). Subsequently, when the card game ends, the master control unit 251 shifts to dividend calculation processing (step S112). In the dividend calculation processing in step S112, the master control unit 251 performs, for example, dividend recalculation related to the jackpot on the basis of the bet information (information representing a bet situation and the like of the side bet) transmitted from the station devices 300 and performs, for example, derivation of progressive dividends for the ranks (“GRAND”, “MAJOR”, “MINOR”, and “MINI”) of the jackpot. Note that values of the progressive dividends calculated by the master control unit 251 are values that can be displayed without being divided by the number of the station devices 300.

Subsequently, the master control unit 251 shifts to step S113 and executes game advance processing. For example, in the bet period, the master control unit 251 calculates a residual time of the bet period, totalizes a bet amount for each of bet positions on the basis of operation information stored in the RAM 213, calculates the number of credits for each of the bet positions and a total number of bet credits, and updates a display image on the main monitor 230.

When shifting to step S114, the master control unit 251 transmits the various data generated in the steps explained above to the station devices 300 and ends the processing.
B-2. Station Device 300

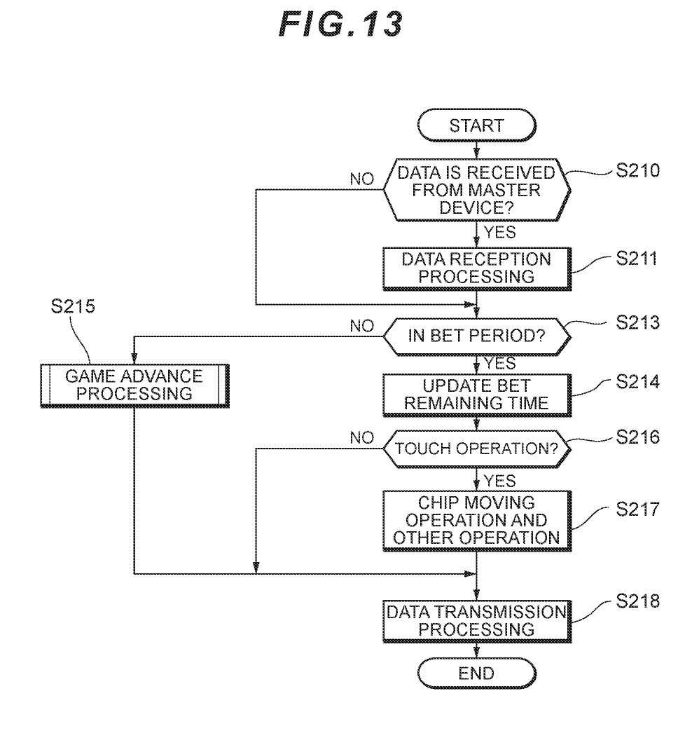

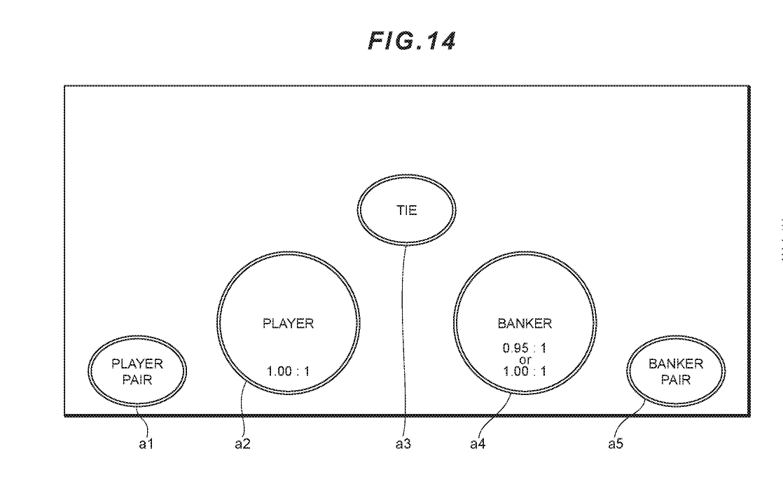

A flowchart for explaining processing executed by the station device 300 is shown in FIG. 13. Master processing related to the flowchart is repeatedly executed periodically (e.g., at every 1/60 second) at every predetermined update timing. Note that processing contents of steps explained below are illustrations. The order of the steps may be changed, a plurality of steps may be processed as one step, or one step may be separated into a plurality of steps and processed.

First, the station control unit 310 of the station device 300 determines whether data is received from the master device 200 (step S210). When determining that data is not received from the master device 200, the station control unit 310 proceeds to step S213 skipping step S211 and determines whether a status of the game at the present point in time is “in the bet period”. When determining that data is received from the master device 200 (YES in step S210), the station control unit 310 discriminates a type of the received data and performs processing of the received data (step S211). Subsequently, the station control unit 310 shifts to step S213 and determines whether a status of the game at the present point in time is “in the bet period”.

When determining that the status of the game at the present point in time is “in the bet period” (YES in step S213), the station control unit 310 shifts to step S214 and updates bet remaining time information. On the other hand, when determining that the bet period ends and the card game should be advanced (NO in step S213), the station control unit 310 shifts to step S215 and executes various kinds of processing related to the advance of the card game. For example, the station control unit 210 sequentially deals out cards to the player and the banker and advances the card game.

On the other hand, in step S216, the station control unit 310 determines whether touch operation is performed by the user. When determining that the touch operation is not performed (NO in step S216), the station control unit 310 proceeds to step S218 skipping step S217, transmits data generated anew at the present update timing to the master device 200, and ends the processing. On the other hand, When determining that the touch operation is performed (YES in step S216), the station control unit 310 performs various kinds of operation corresponding to an operation situation (step S217). For example, when the touch operation is performed on a chip and the touch operation is performed on the same chip at the last update timing, the station control unit 310 determines that moving operation for the chip is performed and moves display of the chip to a new position. Further, when the touch operation is performed on a button or the like other than the chip and the bet position, the station control unit 310 executes other operation allocated to the operated button or the like. The station control unit 310 transmits the data generated anew at the present update timing to the master device 200 (step S218) and ends the processing.

As explained above, with the card game device according to this embodiment, it is possible to perform main bet operation for the existing Baccarat and side bet operation for the new Baccarat full of originality different from the existing Baccarat. Since the user can enjoy the two kinds of Baccarat in one card game in this way, it is possible to obtain amusement that the user cannot enjoy in the conventional card game.

Further, in this embodiment, it is possible to directly perform the side bet operation without performing the main bet operation. Therefore, it is possible to flexibly meet needs of various users.

The appearance ratios of the ranks of the jackpot are changed according to the bet situation of the side bet. Therefore, it is possible to improve amusement of the side bet. Furthermore, concerning the jackpot, the plurality of ranks of “GRAND”, “MAJOR”, “MINOR”, “MINI”, and “-” (blank) are set. The dividends allocated to the respective ranks are different. Therefore, it is possible to further improve amusement of the jackpot compared with the past.
C. Modification

In the embodiment explained above, the form is illustrated in which the main bet (the bet for the “existing Baccarat”) and the side bet (the bet for the “new Baccarat”) are performed in the card game performed once. However, only the bet for the side bet, that is, the “new Baccarat” may be received.
D. Others

Note that, in the embodiment explained above, the Baccarat is assumed as one of the card games in which the player and the banker compete for win or loss. However, the present disclosure is applicable to other card games as well. The present disclosure is not limited to the embodiment. Various modifications are possible as long as the gist of the present disclosure is not changed. For example, as the configurations of the server computer 250 and the station device 300 shown in FIG. 1, a mobile computer, a portable terminal, a game machine, and the like connectable to a communication network can also be used, although processing abilities and the like are different. That is, it is possible to cause various communication devices connected via the communication network to function as the server computer 250 and the station device 300.

Further, network interfaces in the master device 200 and the station device 300 may be either a wireless LAN device or a wired LAN device. The wireless LAN device and the wired LAN device may be mounted on the inside or may be an external device type like a LAN card.

In this embodiment and the like, the card game device 1000 comprising the master device 200 and the station device 300 is explained as an example. However, if the function of the master device 200 is mounted on the station device 300, it is also possible to realize the game device of the present disclosure with only the station device 300 (that is, in a standalone form). The card game explained in this embodiment and this modification may be carried out mainly in a form of a game that makes use of an online computer network, a so-called online game. The users are capable of carrying out the card game explained above by using a general-purpose personal computer and the like accessible to the online game.

### INDUSTRIAL APPLICABILITY

As explained above, the game device and the like of the present disclosure can markedly improve entertainment, amusement, and enjoyability of a game compared with the conventional game devices and the like. It is possible to improve awareness of participation in the game and a desire to continue the game of the player. Therefore, it is possible to widely and effectively use the present disclosure for all software and hardware related techniques for provision, implementation, and the like of games and activities such as design, manufacturing, and sales of the techniques.

### DESCRIPTION OF REFERENCE NUMBERS

1000 card game device
200 master device
230 main monitor
300 station device
310 station control unit
311 CPU
312 ROM
313 RAM
350 display device
352 touch panel
Am main bet area
As side bet area
Aj jackpot area

### FIG. 2

#1 START BET
#2 END BET
#3 END GAME
#4 BET TIME
#5 DEAL
#6 DIVIDEND

### FIG. 4

254 INPUT UNIT
251 MASTER CONTROL UNIT
253 MONITORING DISPLAY
240-1, 240-5 SUB-DISPLAY
230 MAIN MONITOR
252 COMMUNICATION CONTROL UNIT
252a COMMUNICATION INTERFACE
300-N, 300-3, 300-2, 300-1 STATION DEVICE

### FIG. 6

350 DISPLAY DEVICE
352 TOUCH PANEL
370 MUSICAL-SOUND PROCESSING UNIT
371 SPEAKER
381 CALL BUTTON
382 PAYOUT BUTTON
310 STATION CONTROL UNIT
393 BILL IDENTIFYING MACHINE
394 PRINTER
391 Audit KEY
392 RESET KEY

### FIG. 7

Im1 FIRST DIVIDEND RATE INFORMATION (EXISTING BACCARAT)
Im2 SECOND DIVIDEND RATE INFORMATION (NEW BACCARAT)
Im3 DIVIDEND RULE INFORMATION

### FIG. 8

313A BET INFORMATION
313B PROGRESS INFORMATION

### FIG. 10

#1 BET CONTROL PROCESSING
S1 RECEIVE BET OPERATION
S2 UPDATE OF BET SITUATION
S3 BET PERIOD ENDS?
#2 END

### FIG. 11

#1 JACKPOT CONTROL PROCESSING
Sa1 PERFORM BET IN SIDE BET
Sa2 START ROTATION OF JACKPOT REEL
Sa3 CHANGE REEL ARRAY
Sa4 WIN SIDE BET?
Sa5 COLLECT TOTAL AMOUNT OF BET AMOUNT
Sa6 DETERMINE RANK OF JACKPOT
#2 END

### FIG. 12

#1 START
S110 DATA IS RECEIVED FROM STATION?
S111 UPDATE BET INFORMATION
S112 DIVIDEND CALCULATION PROCESSING
S113 GAME ADVANCE PROCESSING
S114 DATA TRANSMISSION AND RECEPTION PROCESSING
#2 END

### FIG. 13

#1 START
S210 DATA IS RECEIVED FROM MASTER DEVICE?
S211 DATA RECEPTION PROCESSING
S213 IN BET PERIOD?
S214 UPDATE BET REMAINING TIME
S215 GAME ADVANCE PROCESSING
S216 TOUCH OPERATION?
S217 CHIP MOVING OPERATION AND OTHER OPERATION
S218 DATA TRANSMISSION PROCESSING
#2 END

1. A card game device that controls progress of a game played between a player and a banker, the card game device comprising:
an input unit that receives bet operation on the player by a user or bet operation on the banker by the user;
a collecting unit that collects a total amount of bet amounts corresponding to the bet operation on the player or the bet operation on the banker when the game ends in a tie;
a memory that stores dividend information that specifies a dividend at a time when the player wins and a dividend at a time when the banker wins; and
a dividend determining unit that determines a dividend amount given to the user on the basis of a win or loss result of the game, a bet situation corresponding to the bet operation on the player or the bet operation on the banker by the user, and the dividend information when the player or the banker wins and win or loss of the game is decided.

2. The card game device according to claim 1, further comprising:
a jackpot drawing unit that performs a drawing of a jackpot when the bet by the user comes true; and
an additional-dividend determining unit that determines, when the user wins the jackpot, using dividend information of a progressive dividend corresponding to the jackpot, an additional dividend amount given to the user.

3. The card game device according to claim 2, wherein
a plurality of ranks with different dividends are present in the jackpot, and
the card game device further comprises a jackpot control unit that controls, according to the bet situation by the user, winning probabilities of the jackpot corresponding to the ranks.

4. A card game device that controls progress of a game played between a player and a banker, the card game device executing a first game for enabling only a bet on the player or a bet on the banker and a second game for enabling the bet on the player, the bet on the banker, or a bet on a tie,
the card game device comprising:
an input unit that receives input operation of the games by a user;
a memory that stores dividend information that specifies dividends related to the games;
a collecting unit that collects a total amount of bet amounts corresponding to bet operation on the player by the user or bet operation on the banker by the user in the second game when the second game ends in a tie; and
a dividend determining unit that determines, on the basis of win or loss results in the games, dividend information corresponding to the games, and a bet situation corresponding to the bet operation in the games by the user, a dividend amount given to the user.

5. The card game device according to claim 4, wherein
a dividend at a time when the player wins, a dividend at a time when the banker wins, and a dividend at a time when the first game ends in a tie are specified in the dividend information related to the first game, and
a dividend at a time when the player wins and a dividend at a time when the banker wins are specified in the dividend information related to the second game.

6. The card game device according to claim 5, wherein the dividend at the time when the player wins and the dividend at the time when the banker wins in the second game are respectively set higher than the dividend at the time when the player wins and the dividend at the time when the banker wins in the first game.

7. A program for causing a computer to execute a card game for controlling progress of a game played between a player and a banker,
the computer including a memory that stores dividend information that specifies a dividend at a time when the player wins and a dividend at a time when the banker wins,
the program causing the computer to function as:
an input unit that receives bet operation on the player by a user or bet operation on the banker by the user;
a collecting unit that collects a total amount of bet amounts corresponding to the bet operation on the player or the bet operation on the banker when the game ends in a tie; and
a dividend determining unit that determines a dividend amount given to the user on the basis of a win or loss result of the game, a bet situation corresponding to the bet operation on the player or the bet operation on the banker by the user, and the dividend information when the player or the banker wins and win or loss of the game is decided.

8. A program for causing a computer to execute a card game for controlling progress of a game played between a player and a banker, the card game including a first game for enabling only a bet on the player or a bet on the banker and a second game for enabling the bet on the player, the bet on the banker, or a bet on a tie,
the computer including a memory that stores dividend information that specifies dividends related to the games,
the program causing the computer to function as:
an input unit that receives input operation of the games by a user;
a memory that stores dividend information that specifies dividends related to the games;
a collecting unit that collects a total amount of bet amounts corresponding to bet operation on the player by the user or bet operation on the banker by the user in the second game when the second game ends in a tie; and
a dividend determining unit that determines, on the basis of win or loss results in the games, dividend information corresponding to the games, and a bet situation corresponding to the bet operation in the games by the user, a dividend amount given to the user.

9. A control method for a card game for controlling progress of a game played between a player and a banker, the control method for the card game comprising:
an input step for receiving bet operation on the player by a user or bet operation on the banker by the user;
a collecting step for collecting a total amount of bet amounts corresponding to the bet operation on the player or the bet operation on the banker when the game ends in a tie; and
a dividend determining step for determining, when the player or the banker wins and win or loss of the game is decided, a dividend amount given to the user on the basis of a win or loss result of the game, a bet situation corresponding to the bet operation on the player or the bet operation on the banker by the user, and dividend information that specifies a dividend at a time when the player wins and a dividend at a time when the banker wins.

10. A control method for a card game for controlling progress of a game played between a player and a banker, the control method for the card game executing a first game for enabling only a bet on the player or a bet on the banker and a second game for enabling the bet on the player, the bet on the banker, or a bet on a tie,
the control method for the card game comprising:
an input step for receiving input operation of the games by a user;
a collecting step for collecting a total amount of bet amounts corresponding to bet operation on the player by the user or bet operation on the banker by the user in the second game when the second game ends in a tie; and
a dividend determining step for determining, on the basis of win or loss results in the games, dividend information corresponding to the games, and a bet situation corresponding to the bet operation in the games by the user, a dividend amount given to the user.
